(19) United States
(12) Patent Application Publication
(10) Pub. No.: US 2013/0113607 A1
(43) Pub. Date: May 9, 2013

(54) RFID OBJECT LOCATION SYSTEM AND METHOD

(71) Applicant: Wallace Bolden, Baltimore, MD (US)

(72) Inventor: Wallace Bolden, Baltimore, MD (US)

(21) Appl. No.: 13/292,021

(22) Filed: Nov. 8, 2011

(51) Int. Cl. G08C 17/02

(52) U.S. Cl. 340/10.1

(57) ABSTRACT

A RFID object location system for tracking relative object location for performing analysis and evaluation of game plays. The system includes a ball object containing an embedded RFID tag, one or more readers for tracking and monitoring the location of the ball object during a game play, a client device for collecting relative location data of the ball object, wherein said client device is configured to provide the collected location data to a data center unit, and a data center unit configured to perform analysis and evaluation of games plays based on the relative object location, system determined game play calls and officiated game play calls.

### FIELD OF INVENTION

The present invention is related to the use of radio frequency identification (RFID) technology to determine the location of moving objects in the field of play.

### BACKGROUND OF THE INVENTION

In sporting events, the determination of objects with the field of play can be an outcome determinative event. For example, in football the placement of a ball can determine if a first down has been achieved or if a touchdown has been scored. In baseball, the location of the ball can determine if a ball or strike has been thrown or if a homerun has been scored.

In prior art designs, the determination of the placement of a ball on the field of play is done in a manual fashion through the combination of non-electronic and visual means. Humans, i.e., referees or umpires are responsible for making these calls. Due to the non-exacting nature of human sight, there is always the possibility of dispute by the sports participants that may not agree with calls made by the referees or umpires.

Disputes over the subjectivity associated with the exactness of the placement of the ball or the determination of the true result of the play causes undesirable disruptions in play. In addition, there are major problems associated with determining the accuracy including visual impairment, lighting, non-uniform field conditions and inclement weather.

Additionally, conventional visual technologies, such as instant replay may be used to determine the location of an object as well. Unfortunately, these technologies do not eliminate the subjective nature of sports, as ultimately, an umpire or referee still makes the final call. Furthermore, this also has the undesirable effect of slowing the speed of the game, as the umpire or referee has to take time to review video tape.

Accordingly, there is a need to provide a mechanism for accurate and reliable determination of an object in the field of play. It would be advantageous for any mechanism that provides location data to do so in a way that causes minimal disruption to a sporting event.

### SUMMARY OF THE INVENTION

Exemplary embodiments disclosed herein includes a system for tracking relative object location for performing analysis and evaluation of game plays which includes a ball object containing an embedded RFID tag, one or more readers for tracking and monitoring the location of the ball object during a game play, a client device for collecting relative location data of the ball object. The client device is configured to provide the collected location data to a data center unit, and the data center unit is configured to perform analysis and evaluation of games plays based on relative object location information, system determined game play calls and officiated game play calls.

Exemplary embodiments disclosed herein includes a method of tracking relative ball object location for performing analysis and evaluation of game plays including collecting data relating to the relative location of a ball object during a game play and determining the relative location of the ball object for the game play using the collected data. A client device determines a game play call for the game play based on the relative location of the ball object. A data center unit stores data relating to determined game play calls in a first database and stores data relating to officiated game play calls for the game play in a second database. A user selects from a graphical user interface analysis and evaluation parameters. The data center unit performs analysis and evaluation of game plays in accordance with the user selected parameters based on relative object location information, system determined game play calls and officiated game play calls.

### BRIEF DESCRIPTION OF THE DRAWINGS

FIG. 1 is an exemplary pictorial representation of a football containing a RFID tag on the outer seam of the football.

FIG. 2 is an exemplary pictorial representation of a football embedding a RFID tag internally.

FIG. 3 is an exemplary pictorial representation of a baseball containing a RFID tag on the outer seam of the baseball.

FIG. 4 is an exemplary pictorial representation of a baseball embedding a RFID tag internally.

FIG. 5 is diagram illustrating an exemplary embodiment of a RFID object location system.

FIG. 6 is an exemplary pictorial representation of a yardage marker containing a RFID reader for determining relative ball object location.

FIGS. 7A-7B are block diagrams illustrating an exemplary method of RFID object location.

### DETAILED DESCRIPTION

The present disclosure describes a system and method for tracking an object's location for performing analysis and evaluation of game plays. The system includes a RFID tag and a plurality of readers for tracking and monitoring the location of an object. The location data is collected and stored for processing. The system includes a data center unit to perform analysis and evaluations of game plays. Although exemplary embodiments have been disclosed with respect to the game of baseball, the disclosed embodiments can be used with any ball handling sport.

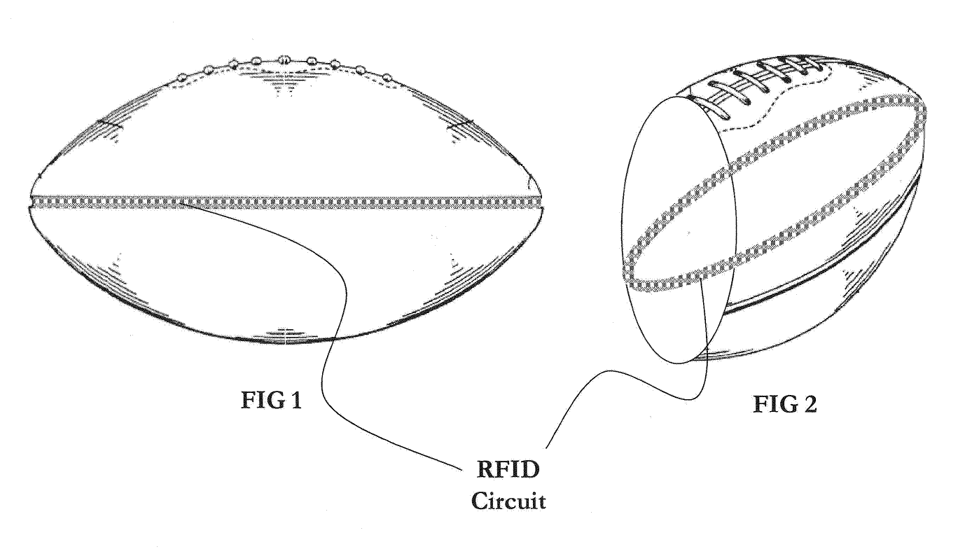

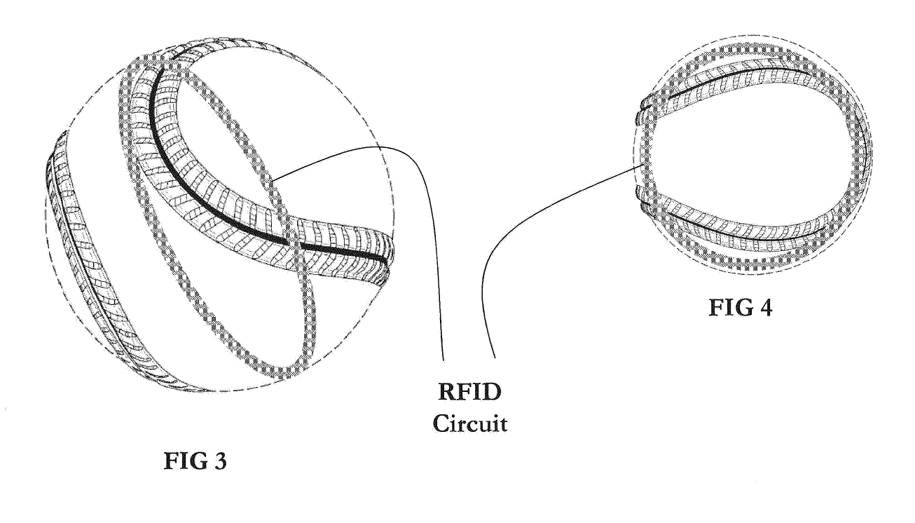

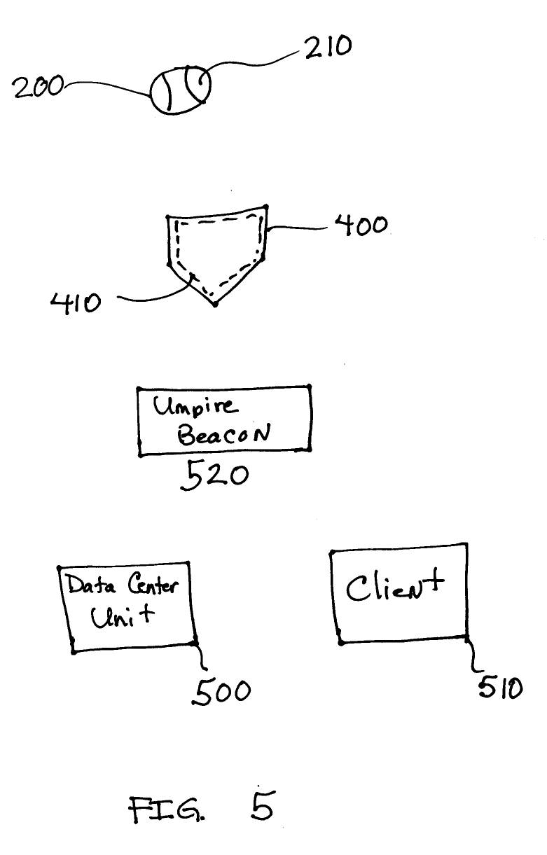

To overcome the shortcomings of the prior art, an aspect of the present invention is to determine the precise location of an object in the field of play using RFID technology. For example, an object used in the field of play can be a ball. As shown in FIGS. 1-4, an RFID tag can be embedded in a ball object. In FIGS. 2-3, the RFID tag is embedded inside a ball object, such as, for example, a football or baseball. In FIGS. 1 and 4, the RFID tag is embedded along the outer seam of a ball object, such as, for example, a football or baseball. One or more RFID readers, designed to sense the RFID tag in an object, are placed at targeted boundary locations, which correspond to game play calls of a particular game, to determine the relative location of the object. Game play calls correspond to the formal calls made on game plays, usually by an officiator, according to the rules of the game.

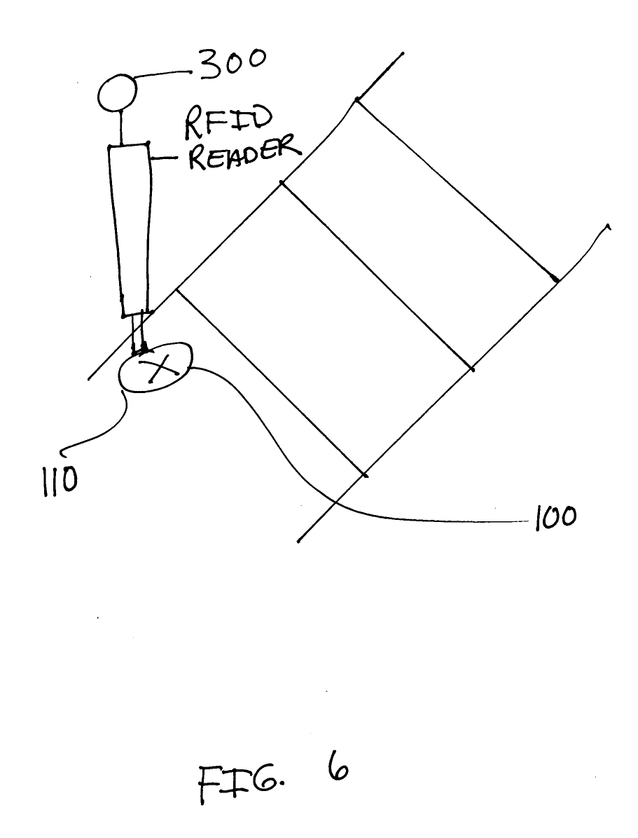

FIG. 5 shows a system according to aspects of the present invention. A ball object, e.g., baseball 200, is embedded with RFID tag 210. One or more RFID readers are placed at targeted boundary locations. For example, in a baseball game, reader 410 may be placed at the home plate, and inside the uniform of a batter to create a scanning field in the strike zone. Furthermore, one or more readers may be placed in the catcher's uniform and/or vest to establish a bypass strike zone scanning field. The ball object, containing the RFID tag, will detect an activation signal from one or more of the readers as it passes through one or more scanning fields established by the readers.

This process will activate the circuit in the RFID tag and a signal will be transmitted back to the one or more readers, which indicates that the ball passed through the strike zone and/or the bypass strike zone. Thereafter, the one or more readers transmit a wireless signal to a device, e.g., device 520, located on an umpire's belt and to client device 510. During a baseball game, this mechanism may be used to determine if a pitch is a strike or a ball (i.e., a game play call).

Device 520 located on the umpire's belt could be a cellular phone, PDA, or a pager. However, one of ordinary skill in the art would recognize that any device that indicates wireless transmission of reader 410 could also be used.

In the game of football, a reader can be placed in a yardage marker. See FIG. 6. As yardage marker 300 senses tag 110 in a football 100, an electronic signal is generated indicating that the ball has been determined to be in a particular location. During a game, this mechanism may be used to determine a first down (i.e., a game play call).

As illustrated in FIG. 5, the exemplary system includes client device 510 and data center unit 500. The client device is located locally relative to where the game is played (e.g., in the stadium where the game is played) and can be a device or system for receiving, storing, and/or processing data, and for providing information to data center unit 500. The client device can be implemented as one or more computer systems including, for example, a personal computer, minicomputer, microprocessor, workstation, mainframe, or similar computing platform.

Client device 510 includes a controller and data storage device (not shown). The controller can include one or more microprocessors, computer readable memory (e.g., read-only memory (ROM), random access memory (RAM), mechanisms and structures for performing I/O operations. The controller can execute an operating system for execution on the central processing unit and one or more application programs to control the operation of the client device. The data storage device stores one or more databases, the operating system and one or more application programs. The client device includes a network for wireless communication with readers 410, device 520 and data center unit 500.

Further, client device 510 includes a reader location database. There is an entry in the database for each reader in the system and each entry includes the following information {<reader ID>, <location ID>, <relative boundary location>}. The reader ID is an identifier used to identify which reader is transmitting an electronic signal to the client device. The location ID is an identifier used to identify the actual physical location of the reader, for example, the catcher's uniform. The relative boundary location indicates which boundary region the reader is in, for example, the catcher's uniform location is located in the bypass strike scanning field (i.e., relative boundary location) and the readers located in the batter's uniform are located in the strike zone scanning field. The relative boundary locations are used for determining system game play calls based on game rules.

Data center unit 500 is located at a remote location (e.g., headquarters) and includes one or more servers, one or more storage devices, a control unit and a network system for wireless communication with client device 510. Each server includes one or more microprocessors, computer readable memory (e.g., read-only memory (ROM) and random access memory (RAM)), mechanisms and structures for performing I/O operations.

Data center unit 500 also includes one or more storage devices and a storage controller and database manager. The storage device can be implemented with a variety of components or subsystems including, for example, a magnetic disk drive, an optical drive, flash memory, or any other devices capable of persistently storing information. The storage device includes one or more databases.

Storage controller and database manager include one or more microprocessors, computer readable memory (e.g., read-only memory (ROM) and random access memory (RAM)), mechanisms and structures for performing I/O operations. Storage controller and database manager can execute an operating system for command execution on the one or more microprocessors and an application program for controlling the operations of the storage device(s) and database(s). The application program can be developed using any suitable computer programming language, such as, for example, Java programming.

Data center unit 500 includes a first database for storing data related to system determined game play calls and a second database for storing data related to actual game play calls by an officiator (e.g., umpire, referee, etc.). A system determined game play call is a game play call determined by client device 510 during a game play. In contrast, an officiated game play call is a call made by the officiator of the game during a game play.

The first database includes an entry for each system determined game play call. For example, in a baseball game, each entry can include the following information {<inning>, <play #>, <umpire ID>, <pitcher ID>, <batter ID>, <game play call ID>}. Inning is a four digit binary number identifying the current inning corresponding to the system determined game play call. Play # is a four digit binary number which is used to identify the current play corresponding to the system determined game play call.

Each umpire is assigned an ID (e.g., four digit binary number) to identify the umpire officiating the game during the system determined game play call. The pitcher ID is an identifier used to identify the pitcher of the game during the system determined game play call. The batter ID is an identifier used to identify the batter at the time of the system determined game play call. Each game play call is associated with a binary identifier to identify the game play call. A game play call can be, for example, strike, foul, ball, out of bounds, first down, etc. A game play call ID, such as, for example, 0011, can be used to identify a strike game play call.

The second database includes an entry for each officiated game play call. Each entry includes, for example, in a baseball game, the following information {<inning>, <play #>, <umpire ID>, <pitcher ID>, <batter ID>, <game play call ID>}. Inning is a four digit binary number identifying the current inning corresponding to the officiated game play call. Play # is a four digit binary number which is used to identify the current play corresponding to the officiated game play call. The umpire ID is an identifier used to identify the umpire officiating the game during the officiated game play call. The pitcher ID and batter ID are identifiers used to identify the pitcher/batter, respectively, of the game during the officiated game play call. The game play call ID is used to identify the officiated game play call.

The data center unit 500 includes a graphical user interface (GUI) for allowing user selection of performance and evaluation parameters. The GUI is a menu-driven user interface. The data center unit uses the data in the first and/or second databases to perform analysis and evaluations of game plays according to the parameters selected by the user. The data center unit includes algorithms for computing performance metrics, and performing analysis and evaluations of game plays.

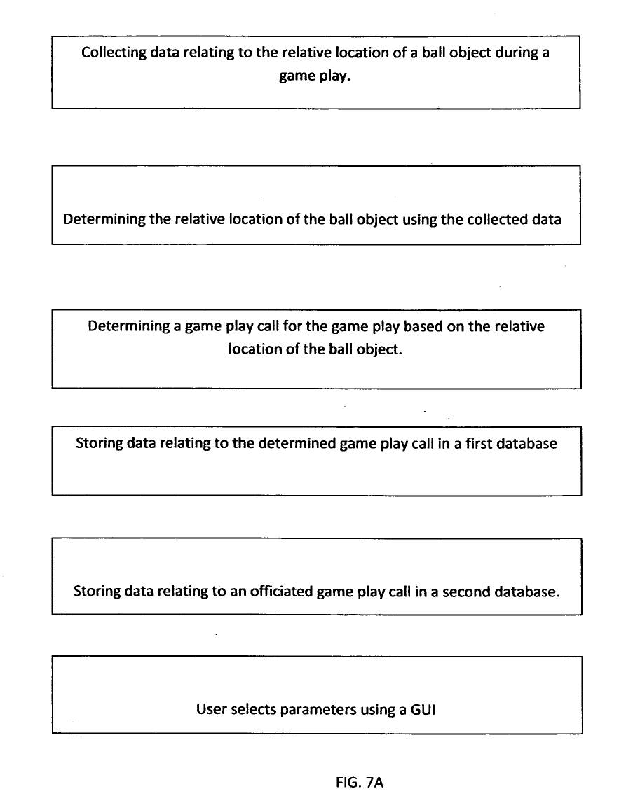

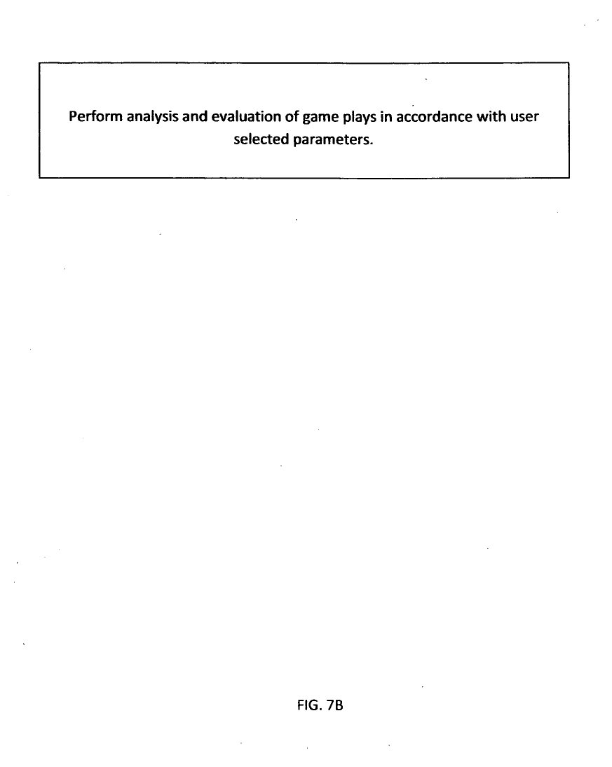

FIGS. 7A-7B illustrate the operations of the system in tracking relative object location for performing analysis and evaluation of game plays. At step 710, client device 510 collects/receives signals from one or more readers 410 relating to the ball object. The client device determines the relative location (i.e., relative boundary location) of the ball object by parsing the reader location database using the collected data (i.e., reader ID and/or location ID), at step 720.

Client device 510 uses the relative boundary location(s) to determine system game play calls, at step 730. For example, in a baseball game, if client device receives a signal from one or more readers in the batter's uniform and the catcher's uniform, the client would determine that the ball passed the strike zone scanning field (i.e., relative boundary location for the readers in the batter's uniform at bat) and the bypass strike zone scanning field (i.e., relative boundary location for the readers in the catcher's uniform).

Accordingly, client device 510 would determine that the pitch was a strike according to the official game rules of baseball. A strike in baseball results when a batter doesn't swing at a pitch in the strike zone. A ball object would only pass the strike zone scanning field and the bypass strike zone scanning field if the pitcher threw a strike. If the batter hit the ball, the ball would not make it to the bypass strike zone scanning field. Therefore, in the scenario where the ball passes the strike zone and the bypass strike zone scanning field, the client device determines the game play call as a strike. Alternatively, a pitch at which the batter does not swing and which does not pass through the strike zone is called a ball. Thus, if the ball object only passes the bypass strike zone scanning field, the system determines the game play call as a ball.

For each system determined game play call, client device 510 transmits the determined game play call and information related to the game play to data center unit 500. At step 740, the data center unit stores the transmitted data in a first database.

Further, client device 510 receives information from a user responsible for tracking actual game play calls made by a game officiator, e.g., umpire during the game. The information can be received in real time or anytime during or after the game. The client device transmits the received information to data center unit 500. At step 750, data center unit stores the data in a second database.

At step 760, a user selects performance and evaluation parameters from a series of pull down menus on the graphical user interface (GUI). The menus can include a menu to select, for example, in a baseball game, {pitcher, batter, umpire, etc.}, and a menu to input a corresponding ID of the selected entity. Another menu can include, for example, the selection of {grade performance, determine number of strikes pitched, strike error rate, etc.}. The data center unit can include any number of menus for selecting parameters.

The user may select a variety of parameters, such as, for example, rank the performance of officiating personnel, determine accuracy and efficiency of a particular officiator, measure the distance of home runs, measure the officiating performance overall, determine location of lost golf balls, verify/check the system determined game play call for a specified game play, evaluate performance of a particular player, or any other performance or evaluation metrics. The data center unit can include any number of parameters for selection.

At step 780, the data center unit 500 performs analysis and evaluation of games plays in accordance with the user selected parameters based on one or more of the following: relative object location, system determined game play calls and officiated game play calls. For example, in the scenario where the user selects <umpire> <ID> and <grade performance>, the data center unit would execute the algorithm for grade performance.

The grade performance algorithm can include, for example, i) identifying all the game plays officiated by umpire ID from the first and second databases in data center unit, ii) comparing the system determined game play call and the officiated game play call for each play # officiated by umpire ID, iii) determining the number of incorrect officiated game play calls, iv) calculating an accuracy percentage based on the number of incorrect officiated game play calls and v) checking a grading scale to determine performance grade based on accuracy percentage.

The data center unit 500 includes a variety of algorithms to perform analysis and evaluations of game plays in accordance with any parameter selections for any ball handling sport.

The disclosed embodiments are not inclusive and many other modifications and variations will be apparent to someone of ordinary skill in the art with construction skills in the related arts. Together the descriptions and accompanying illustrations seek to provide an explanation of the basic principles of the embodiment and its application.

Moreover, while illustrative embodiments of the invention have been described herein, further embodiments can include equivalent elements, modifications, omissions, combinations (e.g., of aspects across various embodiments) adaptations and/or alterations as would be appreciated by those skilled in the art based on the present disclosure.

As disclosed herein, embodiments and features of the invention can be implemented through computer hardware and/or software. Such embodiments can be implemented in various environments, such as networked and computing-based environments with one or more users. The present invention, however, is not limited to such examples, and embodiments of the invention can be implemented with other platforms and in other environments.

Other embodiments of the invention will be apparent to those skilled in the art from consideration of the specification and practice of the embodiments of the invention disclosed herein. Further, the steps of the disclosed methods can be modified in various manners, including by reordering steps, executing multiple steps concurrently, and/or inserting or deleting steps, without departing from the principles of the invention. It is therefore intended that the specification and embodiments be considered as exemplary only.

What is claimed:

1. A system for tracking relative object location for statistical analysis and evaluation of game plays comprising:
a ball object containing an embedded RFID tag;
one or more readers for tracking and monitoring the location of the ball object during a game play;
a client device for collecting relative location data of the ball object, wherein said client device is configured to provide the collected location data to a data center unit; and
a data center unit including:
a first database for storing data related to system determined game play calls during a game play;
a second database for storing data related to actual game play calls made by an officiator during a game play;
a graphical user interface (GUI) for allowing user selection of performance and evaluation parameters; and
a processing unit configured to perform analysis and evaluation of games plays in accordance with the user selected parameters based on one or more of the following: relative object location, system determined game play calls and officiated game play calls.

2. The system of claim 1, wherein the processing unit comprises algorithms for computing performance metrics.

3. The system of claim 1, wherein the processing unit comprises algorithms for performing analysis and evaluations of game plays.

4. The system of claim 1, wherein the processing unit evaluates game plays by comparing the system determined game play calls and officiated game play calls.

5. The system of claim 1, wherein the processing unit evaluates game plays by comparing the system determined game play calls and officiated game play calls for a particular umpire.

6. The system of claim 1, wherein the game play call is selected from the group consisting of: strike, first down, ball, touch down, out of bounds, or any other official game play calls corresponding to the rules of a game.

7. The system of claim 1, wherein the one or more readers are positioned at specific boundary locations that correspond to a particular game play call.

8. The system of claim 1, wherein the game play is a real time play of a game, wherein the game is selected from the group consisting of: baseball, football, tennis, golf, hockey, soccer.

9. The system of claim 1, wherein the ball object is selected from the group consisting of: football, tennis ball, golf ball, baseball, soccer ball,

10. The system of claim 1, wherein the data center unit performs analysis and evaluation of games plays to determine accuracy and efficiency of officiating.

11. The system of claim 1, wherein the data center unit performs analysis and evaluation of games plays to rank the performance of officiating personnel.

12. The system of claim 1, wherein the GUI is a menu-driven user interface.

13. A method of evaluating officiating of game plays based on statistical analysis data comprising the steps of:
collecting data, by a client device, relating to the relative location of a ball object during a game play;
determining, by the client device, the relative location of the ball object for the game play using the collected data;
determining, by the client device, a game play call for the game play based on the relative location of the ball object;
storing data, by a data center unit, relating to the determined game play call in a first database;
storing data, by the data center, relating to an officiated game play call for the game play in a second database;
receiving, in the data center unit, user selected analysis and evaluation parameters from a graphical user interface (GUI); and
performing, by the data center unit, analysis and evaluation of game plays in accordance with the user selected parameters based on one or more of the following: relative object location, system determined game play calls and officiated game play calls.

14. The method of claim 13, wherein the data center unit executes one or more algorithms to perform analysis and evaluations of game plays.

15. The method of claim 14, wherein an executed algorithm includes grading the performance of an umpire.

16. The method of claim 15, wherein the algorithm for grading the performance of an umpire includes comparing system determined game play calls and officiated determined game play calls.
